(19) United States
(12) Patent Application Publication
(10) Pub. No.: US 2008/0140557 A1
(43) Pub. Date: Jun. 12, 2008

(54) ON-LINE AUCTION SYSTEM AND METHOD

(75) Inventors: James O. Bowlby, San Jose, CA (US); Chun-Nan Chen, San Jose, CA (US); Stephen P. Aranoff, Sedona, AZ (US)

Correspondence Address: PERKINS COIE LLP, P.O. BOX 2168, MENLO PARK, CA, 94026, US

(73) Assignee: ePatentTrade, Inc., Sedona, AZ (US)

(21) Appl. No.: 11/749,407

(22) Filed: May 16, 2007

Related U.S. Application Data
(60) Provisional application No. 60/850,591, filed on Oct. 10, 2006.
(60) Provisional application No. 60/922,559, filed on Apr. 9, 2007.

(51) Int. Cl. G06Q 30/00

(52) U.S. Cl. 705/37

(57) ABSTRACT

A method and exchange for buying and selling rights in a legal contract or patent through an on-line exchange are disclosed. After obtaining a transfer of certain rights from the owner, and setting a transaction period during which the transferred rights can be bought and sold, the transferred rights are divided into fractions which can then be bought and sold, under buyer/seller exchange conditions. The bidding for fractions continues until a termination event occurs, which may be the expiration of the set transaction period or one of the participant buyer's acquiring a specified number of fractions of the transferred rights, in which case that participant can become the legal owner of the rights by acquiring all other ownership fractions in the rights at a predetermined price.

This application claims priority to U.S. Provisional Patent Application Nos. 60/850,591 filed Oct. 10, 2006 and 60/922,559 filed Apr. 9, 2007, both of which are incorporated herein in their entirety by reference.

### FIELD OF THE INVENTION

This invention generally relates to online trading and specifically to the assignment and exchange of fractions relating to the ownership and use of contractual rights, including intellectual property rights.

### BACKGROUND OF THE INVENTION

As envisioned by our constitution, a patent for an invention is the grant of a property right to the inventor, issued by the United States Patent and Trademark Office (USPTO). The right conferred by the patent grant is the right to exclude others from making, using, offering for sale, selling or importing the invention. Today, the patents themselves are big business, traded and sold between very large companies. However, of the thousand patents issued each day, nearly half go to individual inventors who often do not have the large financial resources necessary to commercialize their own inventions. Consequently, individual inventors tend to lose out on the rewards they could achieve if they could continue their innovations. So too does society at large miss out on any advances that might come from the early and aggressive commercialization of these patents.

Some inventors use their patents as key assets to start businesses, funded either with their own money or venture capital. However, others are not so fortunate. In the event an inventor wishes to let others commercialize his patent, the market only offers inefficient and cumbersome channels to help him sell his patent. For example, an inventor may contact corporations directly, enlist intermediaries such as brokers (Intellectual Ventures, Inflexion Point Strategies) or facilitators (yet2.com, Tynax, Ocean Tomo), or try to sell his patent directly through online auctions (eBay.com, IPAuctions.com, patentman.com).

However, these sales channels suffer from serious structural and operational problems, such as the lack of liquidity and price discovery, high cost and low efficiency. It can take months or years between the time a patent is offered and the time it is purchased, either outright or in some form of license. There is also no objective way to uncover the fair value of a patent since there are only two or three parties involved in the negotiation; the price could easily deviate wildly depending on perceived value and the flexibility or even the desperation of buyers or sellers. Due diligence, sales contracts with license backs, or any variety of licensing agreements attempt to insure a future cash flow by crafting multiple contingencies into tough contracts, a process that can be both time consuming and quite expensive.

Fortunately, these problems have been generally solved in other financial markets such as tangible commodities, corporate securities, debt instruments, market indices, real estate investment trusts, currency trading and derivatives. Their solution is to involve investors directly in the trading process. Multiple investors form an intermediary buffer between a sale on the one side and a purchase on the other, separating the two events in time and thereby removing a serious constraint to liquidity. Until now, no mechanism has been devised to involve investors in the trading of intellectual property. Our invention describes new methods that allow investors to easily and efficiently trade fractions of intellectual property. Investors provide liquidity and price determination in exchange for the potential to realize profits. Inventors benefit from quick access to the funding provided by investors. Users of patents can license patents quickly and efficiently from the open marketplace. Mechanisms for obtaining exclusive ownership of patents are also disclosed. Trading intellectual property poses unique problems that are solved by the methods described in this invention.

Prior art describes computerized markets for collectible goods. For example, U.S. Pat. No. 5,845,265 (Woolston, Dec. 1, 1998) describes a method for creating a computerized market for used and collectible goods using low cost posting terminals. U.S. Pat. No. 6,085,176 (Woolston, Jul. 4, 2000) teaches a method of searching a plurality of electronic markets to locate a desired item. U.S. Pat. No. 6,202,051 (Woolston, Mar. 13, 2001) describes a computerized auction for used goods or collectibles wherein the seller uniquely identifies the entire item and the buyer purchases the entire item. U.S. Pat. No. 6,266,651 (Woolston, Jul. 24, 2001) relates to used and collectible goods offered for sale by an electronic network of consignment stores. None of these patents describe the exchange of patent fractions, or the exchange of fractions of one or more contractual rights.

Additional prior art describes an online trading environment. U.S. Pat. No. 6,058,417 (Hess and Wilson, May 2, 2000), U.S. Pat. No. 6,415,320 (Hess and Wilson, Jul. 2, 2002), U.S. Pat. No. 6,732,161 (Hess and Wilson, May 4, 2004), and U.S. Pat. No. 7,007,076 (Hess and Wilson, Feb. 28, 2006) relate to information presentation and management in an online trading environment, such as an online shopping site, an online auctioning site, an online e-commerce site, an online person-to-person trading site, or the like, specifically to descriptions, URLs and images of products. None of these patents relate to intellectual property or fractions thereof, or the exchange of fractions of one or more contractual rights.

Additional prior art describe innovative online exchanges. For example, U.S. Pat. No. 5,995,947 (Fraser et al, Nov. 30, 1999) describes an interactive mortgage and loan information and real-time trading system. U.S. Pat. No. 6,115,698 (Tuck et al, Sep. 5, 2000) teaches a common marketplace to buy and sell electric energy. U.S. Pat. No. 6,195,647 (Martyn et al, Feb. 27, 2001) describes an on-line transaction processing system for security trading. U.S. Pat. No. 6,615,187 (Ashenmil et al, Sep. 2, 2003) teaches a method of securitizing and trading real estate brokerage options. U.S. Pat. No. 7,035,820 (Goodwin, Apr. 25, 2006) generally relates to systems and methods for providing information relating to financial products such as commercial loans and embodiments of the invention are directed to a data processing system for buying, selling, trading, originating, and providing information on financial products over a computer network, such as the Internet. U.S. Pat. No. 7,039,610 (Morano, et al) teaches a system for trading in a futures trading market wherein a computer based trading system implies spread markets from multiple real or implied spread markets. None of these patents relate to intellectual property or fractions thereof, or the exchange of fractions of one or more contractual rights.

In a larger context, our patent not only deals with intellectual property, but also with any right conferred to a contract owner by a contract. The same process we developed and implemented to trade patent fractions applies to any right conferred by a contract. It would be beneficial to devise mechanisms and systems that fractionate contract rights owned by a contract owner prior to selling said rights to a buyer. Such fractionation would provide liquidity and price discovery. One market that could benefit from rights fractionation is the intellectual property market.

### SUMMARY OF THE INVENTION

In one aspect, the invention includes a method for buying and selling, through an on-line exchange, ownership, license or conditional rights in a legal contract, patent, trademark, or copyright. The method includes the steps of:
(a) obtaining a conditional transfer of such rights, subject to certain conditions being met, and setting a transaction period during which the transferred rights may be bought and sold on the exchange,
(b) dividing the transferred rights into fractions, each of which represents a defined fraction of the transferred rights;
c) allowing the individual fractions of transferred rights to be bought and sold by participants in the exchange, whereby buyer participants can purchase one or more of said fractions from seller participants at agreed upon prices during the transaction period, and
(d) continuing the buying and selling of fractions until the earlier of the following terminating events occurs:
(i) if the transferred right is an ownership right, one of the participants acquires an dominant ownership interest in the transferred rights by acquiring a specified percentage of fractions of the transferred rights, in which case that participant can become the owner of the transferred ownership rights by acquiring all other ownership fractions in the rights at a predetermined price; or
(ii) the specified transaction period expires.

The conditional transfer of rights in step (a) may be by assignment from the owner of the rights or by a promise from the owner to transfer such rights upon certain conditions being met.

The type and number of fractions of transferred rights in step (b), and the transaction period during which the transferred rights can be bought and sold, may be set by the owner of the rights and revealed to all of the participants.

The owner of the rights may choose whether the number of fractions will remain fixed during said transaction period, or can be split if the price rises above a specified price limit, or reverse split if the price falls below a specified price limit. The owner of the rights can choose to publicly disclose throughout the exchange the number of fractions owned by that owner.

Step (d)(i) of the method may include recording the intention of a buyer participant to acquire a full ownership interest in the transferred ownership rights, and allowing that participant a given period of time in which to acquire the specified number of ownership fractions. In this step, the buyer participant may be the only purchaser allowed to purchase fractions for said given period of time. If two or more buyer participants record their intention to acquire full ownership interest in the contract rights, the method may further include conducting an auction in which the two or more interested buyers bid for the right to be the sole buyer participant.

The transferred rights may be license or conditional rights to use a patent for a specified period of time that is a percentage of the unexpired period of the patent, and the fractions bought by a participant buyer may be sold to another participant buyer or bought by a participant buyer who has acquired a full ownership interest in the patent.

Where the transferred right is a patent ownership right, the percentage of fractions that triggers the end of the bidding and selling in step (d)(i) may be between 50 and 80 percent of the fractions of the transferred ownership rights, and the specified time period that triggers the end of the bidding in step (d)(i) may be greater than 6 months and up to the expiry date of the patent.

The exchange in the method may be a continuous auction market that includes:

(a) members who join the exchange by signing a contract in which they agree to abide by the rules of the exchange;
(b) an owner of rights who receives from the exchange fixed amounts of one or more types of fractions;
(c) a means by which members who own fractions can post asks to sell fractions, said ask offers remaining in effect for said transaction period, until the fractions are purchased, or until said member withdraws said post;
(d) a means by which members who wish to purchase fractions can post bids to buy fractions, said bid offers remaining in effect for said transaction period, until the fractions are purchased, or until said member withdraws said post;
(e) a means of displaying throughout the exchange the maximum bid and minimum ask for each type of fraction; and
(f) a mechanism for generating sales when the maximum bid price becomes greater than or equal to the minimum ask price.

Also disclosed is an on-line exchange for buying and selling ownership, license or conditional rights in a legal contract, patent, trademark or copyright, where such rights have been conditionally transferred to the exchange. The exchange comprises:
(1) a website server for communicating with participant computer terminals for exchanging information between participants, and
(2) a machine-readable storage medium operable on the server to carry out the operations of:
(a) storing bid and ask prices for fractions that each represent a defined percentage of the transferred ownership, license or conditional rights; as these prices change over time,
(b) determining when bid and ask prices intersect, and in response, transferring fractions from seller to buyer participants,
(c) determining that a termination event has occurred when (i) one of the participants acquires a dominant ownership interest by acquiring a specified number of fractions of transferred ownership rights, or (ii) a time period specified for the conditional transfer of rights expires, in which case all fractional ownership rights in said fractions are forfeited by non-owner participants has occurred,
(d) if the termination event is (ci), determining an ownership fraction price for all outstanding ownership fractions, and presenting this price to the participant who has acquired a dominant ownership interest by acquiring such specified number of ownership fractions, and
(e) if the termination event is (cii), closing all further bidding on and selling of fractions and informing all participants with ownership fractions that their fractions have expired.

The exchange may provide an escrow account into which an owner of the rights can conditionally transfer the rights for a specified period of time or until certain conditions precedent are met.

These and other objects and features of the invention will become more fully apparent when the following description of the invention is read in conjunction with the accompanying drawings

### BRIEF DESCRIPTION OF THE FIGURES

FIG. 1 diagrams the overall patent trading process.

FIG. 2 shows the trading software design pattern.

FIG. 3 breaks the first screen of the user interface into distinct areas.

FIG. 4 is an example of the first screen of the user interface.

FIG. 5 shows the second screen of the user interface.

FIG. 6 is an example of information displayed in the scrolling region of the second screen of the user interface.

FIG. 7 shows the first screen of contractual items.

FIG. 8 shows the second screen of contractual items.

FIG. 9 breaks the first screen of the trading software into screen areas.

FIG. 10 shows the second screen of the trading software.

FIG. 11 shows the third screen of the trading software.

FIG. 12 diagrams the database schema.

FIG. 13 shows the software flow of posting a bid or ask, or deleting a bid or ask.

FIG. 14 is a flow diagram for posting a new bid.

FIG. 15 is a flow diagram for deleting a previously posted bid.

FIG. 16 is a flow diagram for posting a new ask.

FIG. 17 is a flow diagram for deleting a previously posted ask.

FIG. 18 is a diagram showing the interaction between exchange actors.

### DETAILED DESCRIPTION OF THE INVENTION

### I. Definitions

The terms below have the following meanings unless indicated otherwise.

“Rights” refer to rights that are legally recognized and enforceable and conferred by a legal contract, patent, trademark, or copyright. Where the subject of the rights is a contract for performance or sale-of-goods contracts between two parties, or among three or more parties, the rights, with respect to a contract owner, can include any or all of the rights that that the legal entity (contract owner) is entitled to under the contract.

“Ownership rights” refers to the rights conferred upon and held by an owner or assignee of full or joint ownership of a contract, patent, trademark, or copyright.

“License right” refers to a license or use rights conferred by a licensor (the person or persons with ownership rights) upon a licensee (the person receiving the license rights). The license rights may extend to the entire rights owned by the licensor, or to some fraction of those rights.

“Conditional rights” mean the right of an investor to acquire an ownership or license right from a contract owner, typically within a given time period and for a specified consideration. The actual ownership or license right comes into being only when the conditions are met. An example is more fully explained in Section III, where in conditional rights (defined as PUCs in Section III) are bought and sold, but do not turn into actual ownership or license rights until they are exercised.

“Fractions” of a right refer to a plurality of legal interests in a right, including any of ownership, license, or conditional rights mentioned above.

A “member” of the exchange is an individual who has applied for membership in an on-line auction, called an exchange, and has agreed to abide by the rules of the exchange. Once the exchange accepts a new member's application, that member may then buy and sell on the exchange fractions of a contract right. Members have different purposes when trading on the exchange. In the case of trading patents, members may choose to focus on: origination of the patent and its fractions, intermediary trading, using the patent, or buying all rights to the patent.

“Member accounts” are either of two accounts: first, the individual bank account of a member external to the exchange, and second, an individual account of a member internal to the exchange. Their internal bank account may contain two general assets: fractions and cash. Using web pages controlled by the exchange, members post requests to buy or sell fractions (bids or asks). To buy a fraction they must have funds in their account. To sell a fraction they must already have the specific fraction in their account. When a posted bid price is greater than or equal to a posted ask price a trade is immediately generated, and fractions and cash are exchanged from the internal accounts of the buyer and seller. When members request funds to be added or removed from their internal account, the exchange executes the requested transfer to or from their external account.

“Exchange” refers to a legal entity whose purpose is to provide for the fair and rapid execution of fraction trades. In compensation for this service, the exchange charges a commission. The exchange records and trades fractions as if they were commodities. The market, based on individual or collective determination of value, is the sole determiner of price.

“Investors” are members who trade on the exchange in the hopes of making a profit. Based on their own research of publicly available information they determine that some fractions they wish to own are undervalued, or fractions they already own are overvalued. Investors provide funds that can quickly flow to the contract owner who lists initial fractions on the exchange, and as such provide much needed liquidity in the intellectual property market. They are also able to discover prices by collectively reviewing the quite large body of publicly available background material and iterating toward stable prices that usually reflects all such information. The exchange, by supporting an open market, allows trading activity to be easily tracked so that historical valuations for different kinds of patents may be more easily studied by investors. Early investors earn profits from their contributions to liquidity and price discovery, while later investors may derive profit from the potential purchase or use of the patent.

“Users” are members who wish to utilize the teachings in a patent for a fixed period of time. It is anticipated that users will often be large corporations. The use fractions they purchase can be bought and sold like any other fraction. However, once they are exercised they are removed from trading and a license for a specified period of time is issued to the holder starting at whatever date he requests. For example, the specified period of time could be one year. In such a case, for complete freedom to operate, a user would purchase and exercise a number of fractions equal the number of years remaining on the patent.

“On-line auction” refers to a business model in which participants bid for products and services over the internet or similar wide-bandwidth communication network. The functionality of buying and selling in an auction format is made possible through auction software that regulates the various processes involved. Of the three generic market structures: (1) the continuous auction, or order driven market, (2) the continuous dealer, or quote driven market, and (3) the periodic call auction (see “Call auction trading”, Schwartz et al., Kluwer Academic Publishers 2003), the most popular, and the preferred embodiment disclosed herein, is the continuous auction market in which buyers and sellers negotiate prices by independently posting and changing bids and asks. Whenever the bid and ask prices cross the auction software generates a binding sale.

“Conditionally transferring rights” refers to the process in which an owner of rights may transfer the rights conferred to him by a contract to other persons or legal entities by constructing a new legal contract that may contain certain conditions that must be met before the contract owner's rights are transferred. The contract owner's rights are herein called conditional rights. The process of specifying the conditions under which the contract owner's rights are transferred is herein called conditionally transferring rights.

“Opening the fractions to bidding and selling” refers to a particular moment in the relationship between contract owners and the exchange. Contract owners register as members of the exchange and clearly describe the rights they own. The exchange then issues them a plurality of electronic certificates each representing a fraction of their rights. The set of electronic certificates contain serial numbers that are individually tracked and recorded during the transaction period. Once a contract owner receives a set of electronic certificates he can start to sell them by posting ask requests on the exchange. The process of the contract owner posting on the exchange the first ask is called opening the fractions to bidding and selling.

“Ownership interest” refers in the embodiment described in Section II below to the percentage of fractions that must be acquired by a participant wishing to purchase all rights conferred by a contract before said participant is declared the new contract owner. In the case of a patent, and as described in Section III below, the potential new patent owner (PNPO) declares to the exchange that he wishes to own all outstanding rights to a particular patent. During a moratorium period, the PNPO is the only exchange member who can purchase fractions called POPs. Three dynamics will ensue: 1) members will attempt to receive the highest price for their POPs, 2) the PNPO will attempt to pay as little as possible; and 3) the moratorium period will expire. Because of the inevitable pressure created by these dynamics, the PNPO cannot be expected to acquire all outstanding POPs Therefore he is only required to acquire a percentage (less than 100%) of the outstanding POPs. This percentage is called the ownership interest necessary to win the rights to the patent, or in the more general case, the rights conferred by any contract. Once the ownership interest is acquired, the remaining fractions must be purchased by the new patent owner at a lower predetermined price.

“Transaction period” refers to a fixed period of time during which contract owners offer their fractionated rights for trading on the exchange. The contract owners ask for money from investors who believe the rights will be sold to a yet unidentified buyer during the transaction period. At the end of the transaction period the fractions become worthless. The fundamental value of a fraction is the price paid by a buyer of all contract rights during the transaction period. The derived value of a fraction is other investor's opinion of the fraction's fundamental value.

The definitions below apply specifically to the embodiment of the invention described in Section III below:

“Original patent owners (OPOs)” refer to the single entity who owns all rights to a patent that is listed on the exchange. For example, 45% of all patents are owned by single inventors or small companies built around a sole invention. Such a single inventor can sign a membership form and become a member of the exchange. He can then sign a contract with the exchange to sell fractions of his patent. This single inventor completely controls the patent and becomes what the exchange calls an original patent owner.

The exchange will not list a patent with multiple inventors until all inventors agree to assign a single individual as the responsible party. This responsible party may well be someone other than one of the inventors. The agreement between inventors is outside the responsibilities of the exchange. This duly specified responsible party is called the original patent owner, or OPO. It is only with this OPO that the exchange will communicate. Consequently, the OPO must become a member of the exchange. The patent will be received from the OPO and, if not purchased during the transaction period, returned to him. Issued fractions will be placed in the OPO's account, and all monies netted from their initial sale will be deposited in the OPO's account. It is the OPO's responsibility, under the terms of his external agreement with the inventors, to properly distribute funds received from the exchange.

“Inventors” refer to the original inventors of a patent, and they may or may not be OPOs. If they are not, they may still become members of the exchange and may trade fractions of their own patent as well as fractions of any other patent offered on the exchange. In the case of patents with multiple inventors, the OPO represents all inventors' interests. There are times when those interests may not align with the interests of one of the patent's inventors. In such a case, an inventor may buy and sell fractions in his own account, separate from the activities of the OPO. Of course, all fractions he purchases would have to initially come from the OPO.

“Investors” refer to members who trade on the exchange in the hopes of making a profit. Based on their own research of publicly available information they determine that some fractions they wish to own are undervalued, or fractions they already own are overvalued. Investors provide funds that can quickly flow to the OPO who lists initial fractions on the exchange, and as such provide much needed liquidity in the intellectual property market. They are also able to discover prices by collectively reviewing the quite large body of publicly available background material and iterating toward stable prices that usually reflects all such information. The exchange, by supporting an open market, allows trading activity to be easily tracked so that historical valuations for different kinds of patents may be more easily studied by investors. Early investors earn profits from their contributions to liquidity and price discovery, while later investors may derive profit from the potential purchase or use of the patent.

“Potential new patent owners (PNPOs)” refer to members who wish to own all outstanding patent rights relating to the underlying patent offered whose fractions are traded on the exchange. They must declare their intentions following the exchange's rules of acquisition, and then must follow a procedure in an attempt to acquire an ownership interest in the patent. If successful, the PNPO continues to purchase remaining fractions at a predetermined price and all outstanding rights to the patent are assigned to the PNPO. The rights that are not assigned are any current licenses which remain in effect. Licenses could have been issued before the patent opened for trading on the exchange, or they could have been issued as a result of exercised patent use fractions, called PUCs and further defined below.

A “POP, or piece of the patent” refers to a fraction of the ownership contractual rights conferred by a patent. It is represented by an electronic certificate issued by the exchange on an underlying patent and initially deposited in the OPO's account. It may be sold and purchased only within the exchange and has no value outside the exchange. A POP is issued for a fixed amount of time called the transaction period and is given specific identification numbers that can only change by carefully regulated splits and reverse splits.

A “PUC, or patent use contract” refers to a fraction of the contractual rights conferred by a patent. It is an electronic certificate issued by the exchange on an underlying patent and initially deposited in the OPO's account. It may be sold and purchased only within the exchange and has no value outside the exchange. A PUC is issued for a fixed amount of time called the transaction period and is given specific identification numbers that can only change by carefully regulated splits and reverse splits.

The purpose of a PUC is to allow the PUC owner to use the underlying patent for a specific period of time, such as one year. In this case, it is a one year license. More specifically, it is a non-exclusive, non-transferable, non-sub-licensable license. The PUC holder may sell his PUC or he may exercise his PUC. If the PUC holder chooses to exercise the PUC he notifies the exchange. The identification number given to the PUC is removed from the exchange's databases of available PUCs and a specific use license is issued to the holder starting on a dates that he specifies. In the preferred embodiment, the use license is valid for one year. Exercised PUCs provide holders with freedom to operate.

“Conditional patent assignment” refers to the first goal of an OPO which is to create tradable fractions (POPs and PUCs) on the underlying patent. In the preferred embodiment, he signs a contract with the exchange in which he assigns the patent to the exchange conditioned upon certain events occurring within a specified period of time called the transaction period (e.g.: seven years). In exchange for the conditional assignment, the exchange issues a fixed number of POPs and PUCs and places them in the OPO's account. The number of POPs and PUCs issued is specified by the OPO.

The conditions of assignment are:

1. a fixed number of POPs are issued to the OPO;
2. a fixed number of PUCs are issued to the OPO;
3. monies netted from the sale of these POPs and PUCs will be promptly deposited into the OPO's bank account; and
4. a member will acquire all rights to the patent according to the rules of acquisition (described fully below) before the end of the transaction period.

If these conditions are not met, the exchange has no rights to said patent and assignment of the patent reverts back to the OPO.

At the end of the transaction period all POPs and unexercised PUCs become worthless and the patent reverts back to the OPO. All exercised PUCs remain outstanding as legal licenses to use the underlying patent for a specified period of time, e.g.: one year.

“Due diligence postings” refer to the several statements warranted by an OPO when he offers a patent to the exchange:

### He is who he says he is.

### A patent has been issued and is rightfully owned by one or more parties.

### Said parties have rightfully assigned the OPO as their representative.

### Said patent is not involved in one or more disputes.

### Said patent has been licensed to certain parties for the certain uses, said parties and uses clearly stated, but to no others.

### The application for said patent honestly disclosed all inventors and prior art.

The exchange will not check these statements nor in any other way take responsibility for their veracity. Instead, it is the responsibility of the buyers to determine the truth of these statements. However, except for a notarized copy of the OPO's signature and the fair and timely posting of reasonable administrative information, the exchange is not responsible for due diligence.

“Rules of acquisition” refers to a process whereby a participant can acquire all rights conferred by a contract. Applied to trading patent fractions on-line, it is a process whereby a member of the exchange can acquire all outstanding rights to a patent whose fractions are traded on the exchange. In the preferred embodiment, the rules consist of the following thirteen steps:

### 1. A member first purchases at least 5% but not more than 10% of the POPs issued on an underlying patent.

2. The member informs the exchange as to his intention to own all rights to this patent. The exchange registers the member as a potential new patent owner (PNPO).

### 3. The exchange announces that a member has become a PNPO. This starts a 1 week period in which other members can request and, if qualified by owning at least 5% of the outstanding POPs, become registered PNPOs.

### 4. At the end of said 1 week period, if there is a single PNPO, a 2 month trading moratorium is established wherein only this PNPO can purchase POPs in order to acquire an ownership interest in the patent.

5. However, at the end of said same 1 week period, if two or more members become registered as PNPOs, the PNPOs must bid for the right to purchase POPs during the next 2 month trading moratorium. The highest bidder wins. Profits, minus commissions, proceed to members holding POPs.
6. During the 2 month trading moratorium no user will be allowed to exercise PUCs. However, PUC holders may exercise their PUCs during a 1 week period between the announcement of a new PNPO and the commencement of the 2 month trading moratorium.
7. Before the 2 month moratorium can begin, the PNPO must deposit enough contingent funds into his account to purchase all POPs and unexercised PUCs. The amount is calculated as the average transaction price for the last year times the number of outstanding fractions (POPs and PUCs). If the fractions have not traded for a year, then the amount is calculated as the average transaction price since the fractions were issued.
8. At the beginning of the 2 month trading moratorium, the PNPO starts to purchase additional POPs by steadily increasing his bid price in order to acquire more POPs. It is anticipated that more and more investors will accept the PNPO's bid as the price increases, by either posting new asks near the PNPO's bid price, or adjusting their ask prices to be within their expectation of the PNPO's bidding range.
9. The PNPO continues to bid until all of the contingent funds are exhausted. The PNPO may continue to bid after the contingent funds are exhausted if the 2 month moratorium has not expired. The PNPO must always maintain a positive balance in his account, i.e., he may not post a bid until such funds are deposited in his account.
10. If the PNPO acquires ⅔ of all POPs during the 2 month trading moratorium he wins an ownership interest in the patent. The exchange registers the PNPO as the new patent owner (NPO). The remaining members who hold POPs must relinquish their POPs and are paid by the NPO the average price over the last year before the first PNPO announcement.

### 11. Users are paid by the NPO the average PUC price over the last year before the first PNPO announcement for their unexercised PUCs.

### 12. If the PNPO did not acquire ⅔ of the issued POPs then he did not acquire an ownership interest in the patent and he becomes another investor who can redeem or hold the POPs he acquired.

13. In the event there were initially two PNPOs and the first PNPO did not acquire an ownership interest in the patent, the remaining PNPO has the choice to start another 2 month moratorium or to cancel his PNPO registration. In the event there were more than two PNPOs, the remaining PNPOs must bid together and the process returns to step 5.

“Patent application assignment” refers to patent applications before patent rights have been granted. Individual inventors contribute substantially to our nation's intellectual property. One of the primary goals of the exchange is to help them commercialize their inventions. Unlike corporations or academic institutions, individual inventors often need assistance before the patent is issued, i.e.: during the patent application process, because it requires serious effort and resources to prepare a convincing and comprehensive patent application. Therefore, the exchange provides processes whereby fractions of regular patent applications and provisional patent applications can be traded.

The normal procedures are modified because there is no issued patent and therefore no contractual rights conferred by a patent. However, a patent is anticipated, and if that issuance materializes, then the future patent rights can be fractionated and traded. The exchange accepts provisional contracts from provisional OPOs (pOPOs) and issues to them provisional POPs and PUCs (pPOPs and pPUCs). Such provisional fractions (pFractions) are assigned serial numbers and traded just like the regular fractions. Since they are highly speculative, pOPOs must accept the market reality that prices may significantly decrease in accordance with increased risk.

### II. The On-Line Method and Exchange

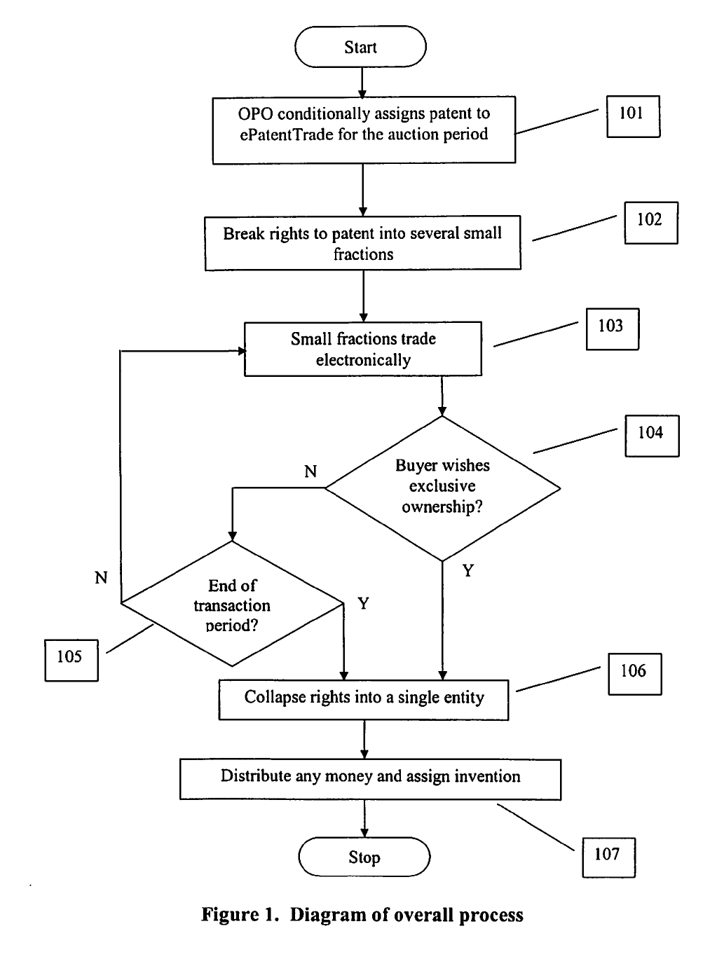

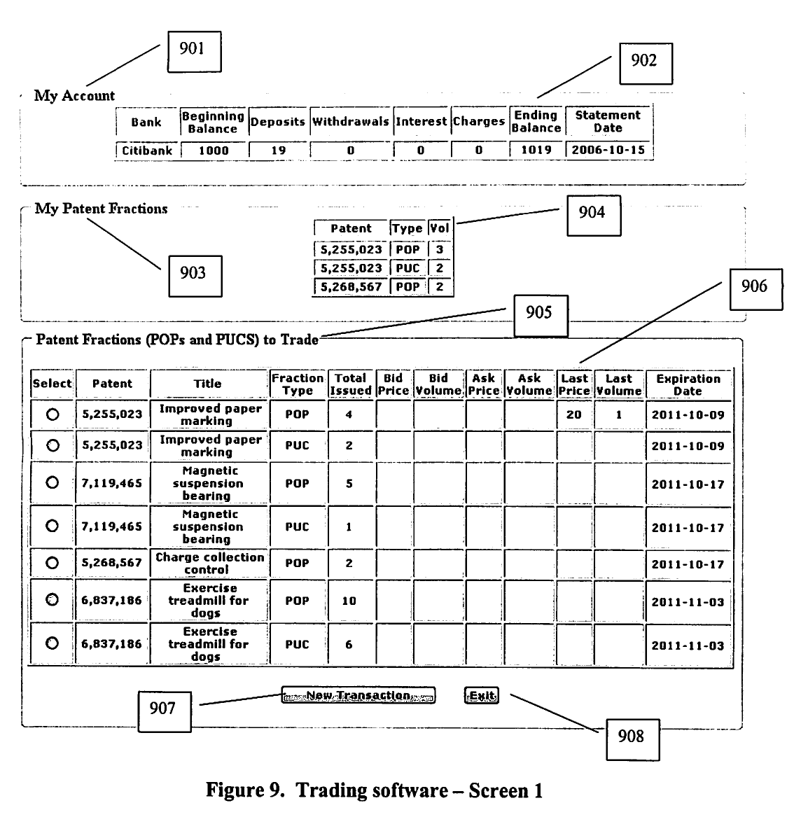

In a general aspect, the invention is directed to a method for buying and selling, through an on-line exchange, ownership, license or conditional rights in a legal contract, patent, trademark, or copyright, and includes the following steps:
(A) Obtaining a conditional transfer of such rights, subject to certain conditions being met, and setting a transaction period during which the transferred rights may be bought and sold on the exchange. In the specific embodiment described in Section III below, this step involves assigning a single owner of the patent, called the OPO (original patent owner), and the OPO conditionally assigning the patent to the exchange for a fixed period of time called the transaction period, as described generally with respect to FIGS. 1-8; It will be appreciated that step (A) can be carried out more generally by obtaining a conditional assignment by the owner of the rights or by obtaining a promise from the owner of the rights to transfer such rights upon certain conditions being met.
(B) Dividing the transferred rights into fractions, each of which represents a defined fraction of the transferred rights; In the specific embodiment described in Section III below, this step involves the exchange issuing to the OPO fixed numbers of patent fractions called POPs (pieces of a patent) and PUCs (patent use contracts), as described generally with respect to FIGS. 1-8; It will be appreciated that step (B) more generally involves having the owner specify the type and number of fractions of transferred rights in step (b), and the transaction period during which the transferred rights can be bought and sold, and this information may be revealed to all of the participants of the exchange.
(C) Allowing the individual fractions of transferred rights to be bought and sold by participants in the exchange, whereby buyer participants can purchase one or more of said fractions from seller participants at agreed upon prices during the transaction period. In the specific embodiment described in Section III below, this step involves investors interacting with the exchange, selecting fractions to trade, posting bids and asks for fractions they wish to buy and sell, and waiting for bid prices to rise above or equal to ask prices, as described generally with respect to FIGS. 9-11, and FIGS. 13-17; More generally, the fractions bought by a participant buyer may be sold to another participant buyer or bought by a participant buyer who has acquired a full ownership interest in the patent
(D) Continuing the buying and selling of fractions until the earlier of the following terminating events occurs:
(i) if the transferred right is an ownership right, one of the participants acquires an dominant ownership interest in the transferred rights by acquiring a specified percentage of fractions of the transferred rights, in which case that participant can become the owner of the transferred ownership rights by acquiring all other ownership fractions in the rights at a predetermined price; or
(ii) the specified transaction period expires.

In the specific embodiment described in Section III below, step D(i) is described with reference to the definition of the “Rules of Acquisition” in Section I above. More generally, it will be appreciated, that in practicing this step:

The method may involve recording the intention of a buyer participant to acquire a full ownership interest in the transferred ownership rights, and allowing that participant a given period of time in which to acquire said specified number of ownership fractions.

The buyer participant may be the only purchaser allowed to purchase fractions for said given period of time.

Where two or more buyer participants record their intention to acquire full ownership interest in the contract rights, the method may further include conducting a transaction in which the two or more interested buyers bid for the right to be the sole buyer participant.

Where the transferred right is a patent ownership right, and the percentage of fractions that triggers the end of the bidding and selling in step (D)(i) may be between 50 and 80 percent of the fractions of the transferred ownership rights, and the time period that triggers the end of the bidding in step specified (D)(i) is greater than 6 months and up to the expiry date of the patent.

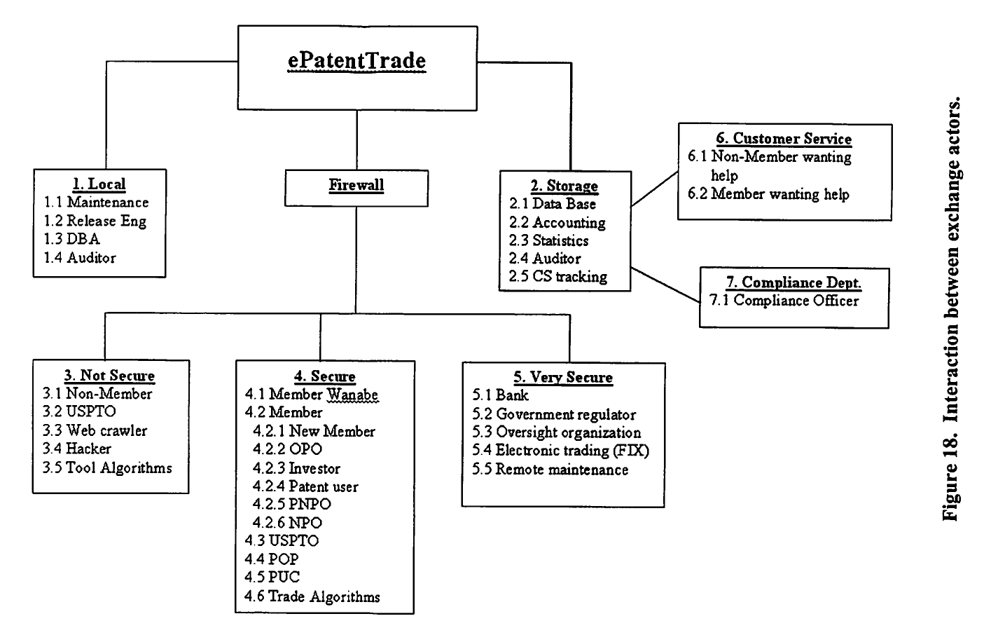

In the specific embodiment described in Section III below, the on-line exchange involves an electronic entity called the exchange and several external actors who can initiate activity that changes the behavior of the exchange, and is described with reference to FIG. 18 and Table 2. More generally, it will be appreciated that the on-line exchange includes:
(1) a website server for communicating with participant computer terminals for exchanging information between participants, and
(2) a machine-readable storage medium operable on said server to carry out the operations of:
(a) storing bid and ask prices for fractions that each represent a defined percentage of the transferred ownership, license or conditional rights; as these prices change over time,
(b) determining when bid and ask prices intersect, and in response, transferring fractions from seller to buyer participants,
(c) determining that a termination event has occurred when (i) one of the participants acquires a dominant ownership interest by acquiring a specified number of fractions of transferred ownership rights, or (ii) a time period specified for the conditional transfer of rights expires, in which case all fractional ownership rights in said fractions are forfeited by non-owner participants has occurred,
(d) if the termination event is (ci), determining an ownership fraction price for all outstanding ownership fractions, and presenting this price to the participant who has acquired a dominant ownership interest by acquiring such specified number of ownership fractions, and
(e) if the termination event is (cii), closing all further bidding on and selling of fractions and informing all participants with ownership fractions that their fractions have expired.

### III. Exemplary Method and System

FIG. 1 summarizes the preferred embodiment of the invention in the form of a flow chart. After becoming a member of the exchange, here shown as an on-line auction run by a company called ePatentTrade, an OPO fills out forms available on the ePatentTrade web site to conditionally assign his patent to ePatentTrade (step 101). ePatentTrade breaks the rights to the invention into several small fractions, either POPs or PUCs, (step 102) that are individually traded in ePatentTrade's on-line exchange (step 103) during some fixed period of time (transaction period). Either of two significant events can then cause trading to cease. First, the transaction period can expire (step 105) at which time the fractions expire (step 106) and the patent is assigned in whole back to the original patent owner (step 107). Alternatively, an entity can bid for and successfully purchase an ownership interest in the patent (e.g.: ⅔ of the issued POPs), and then purchase the remaining POPs and unexercised PUCs, in order to own all outstanding rights to the invention (step 104, 106 and 107).

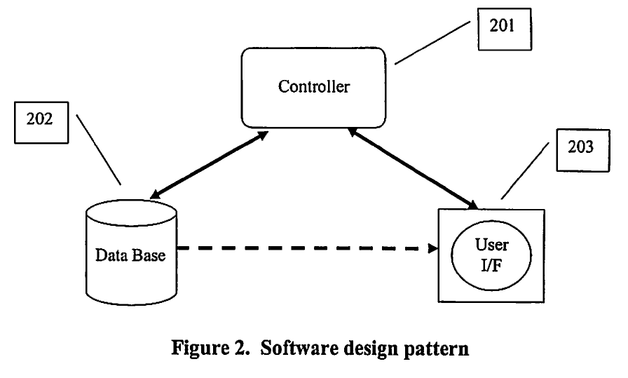

FIG. 2 shows the model-view-controller design pattern used to develop our software. The model is captured in database 202, the view in HTML and PHP software comprising user interface 203, and controller 201 is a collection of primarily PHP software code. Database 202 is read by and written to by controller 201, which also receives information from, and transmits information to, user interface 203. In addition, user interface 203 may request information directly from database 202.

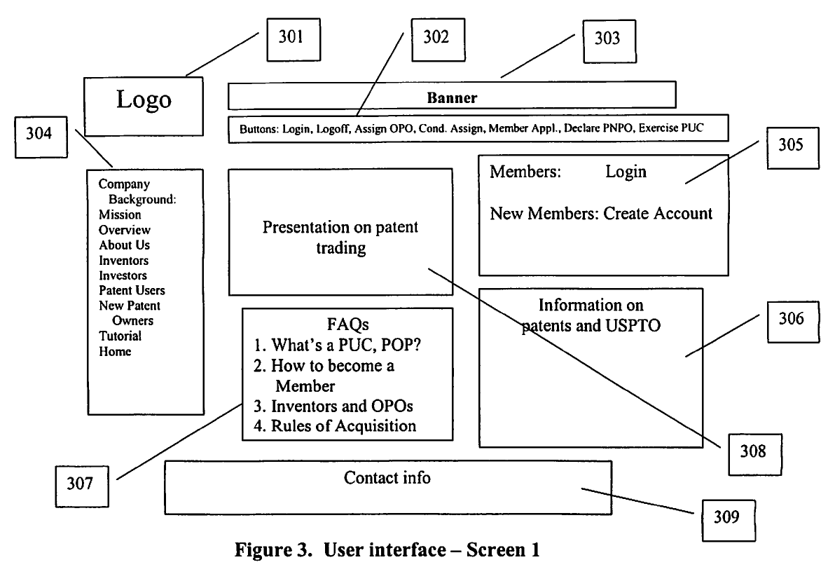

FIG. 3 shows the layout of the first screen members and potential new members see as they log into www.ePatentTrade.com. This page is normally called the “home” page. The page is divided into a number of areas, each displaying different types of information and providing different means by which members may interact with them. Logo 301 is a static area that displays a symbol normally associated with ePatentTrade. Buttons 302 contain active buttons that allow members to perform commonly requested functions, such as: login, logoff, download forms to appoint an original patent owner (OPO) and assign said OPO a patent, interactive screens to conditionally assign a patent to ePatentTrade, apply for membership in ePatentTrade, declare a member's desire to become a potential new patent owner (PNPO), and exercise a PUC. Banner 303 is a moving text region providing a general statement about the nature of ePatentTrade. Interactive links 304 display background material members may find helpful in understanding how the exchange works and how they can post bids and asks. Some links, such as “Mission” display text documents. Others, such as “Tutorial”, display audio-visual presentations about how the trading system works. Login area 305 allows members to log in to their personal accounts and allows new members to apply for membership. Informational area 306 provides general information on patents and information available from www.uspto.gov. FAQ area 307 lists popular questions and links to their answers. Presentation area 308 is a slide presentation describing patent trading, patent valuation, and market dynamics. Information area 309 gives email addresses and contact information for ePatentTrade.

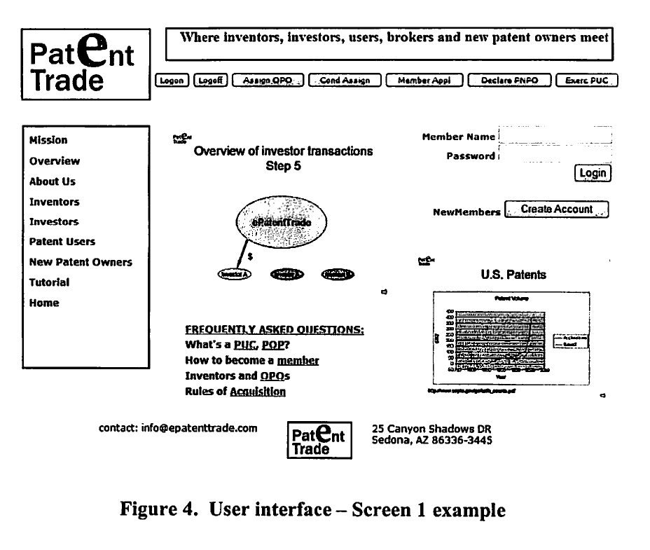

FIG. 4 is snapshot of FIG. 3 as implemented at www.ePatentTrade.com.

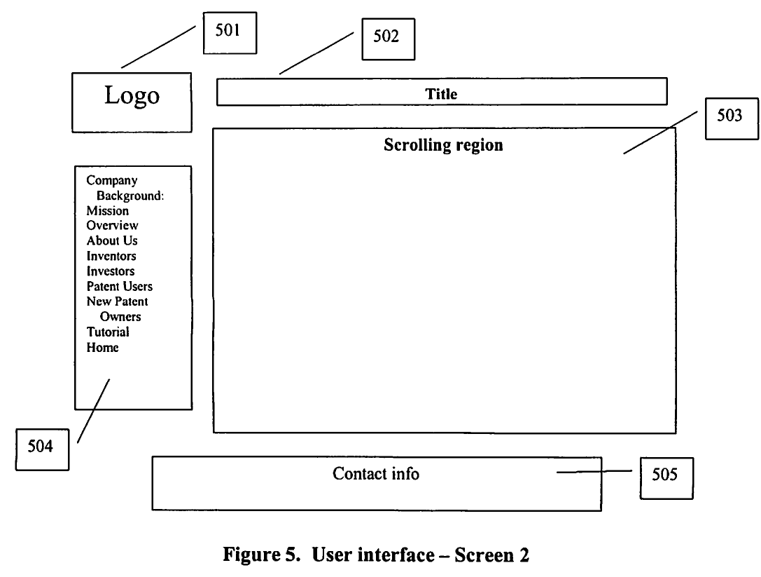

FIG. 5 shows the user interface screen 2 and is used by web page screens pointed to by the home page. Logo 501, information area 504, and contact area 505 are identical to the home page. However, title 502 is now a fixed text area describing the nature of the web page, and scrolling region 503 contains a variety of different types of information, depending on what link the member requested. The purpose of user interface screen 2 is to provide a consistent look and feel as different types of information are presented to the member.

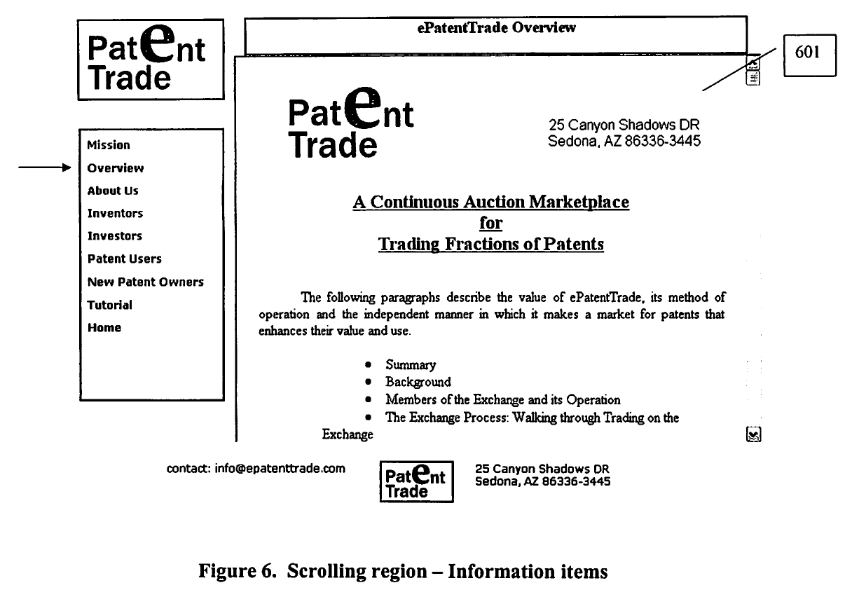

FIG. 6 is an example of an information page (“Overview”) being displayed in scrolling region 601 as implemented at www.ePatentTrade.com.

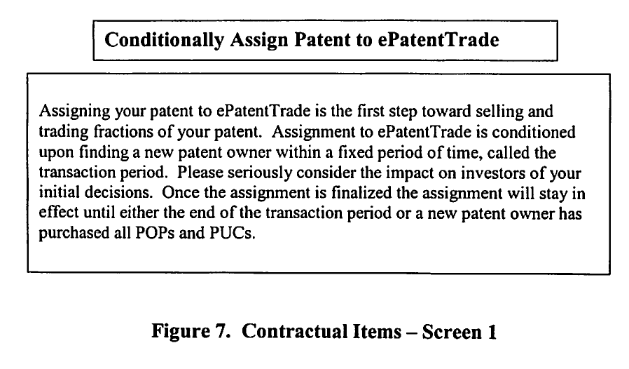

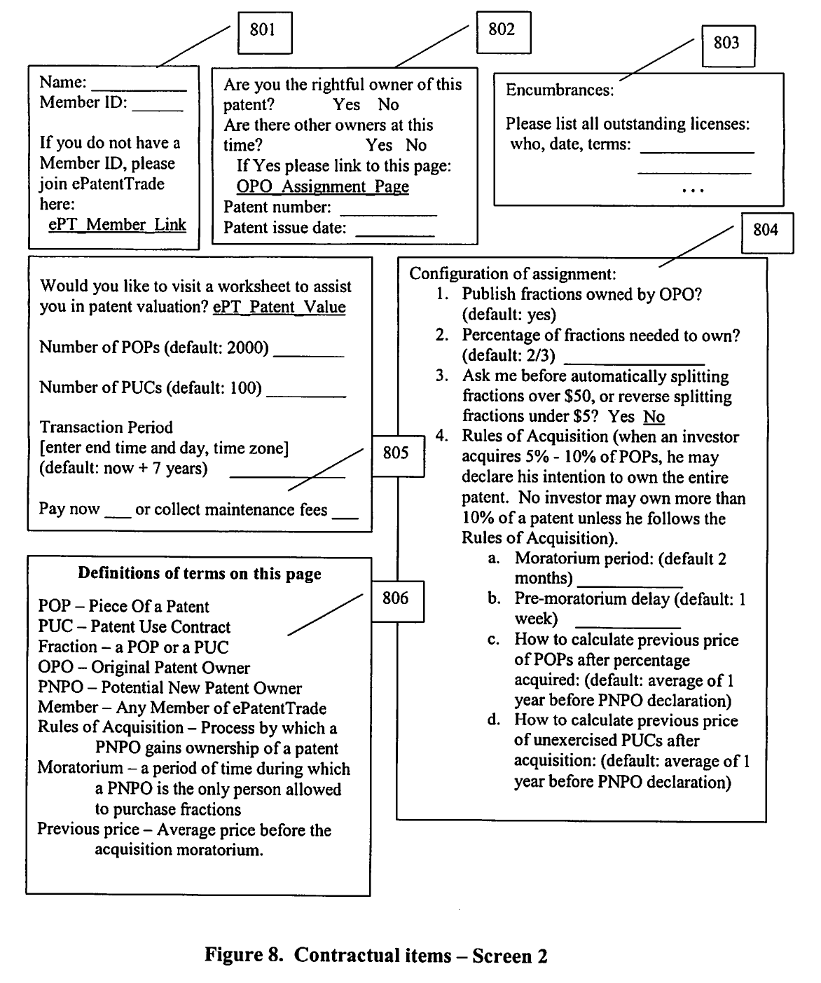

FIG. 7 shows information displayed at the top of scrolling region 503 when the member clicks on the button in area 302 labeled “Cond. Assign”, standing for conditional assignment. FIG. 8 shows information appearing immediately below FIG. 7. OPOs enter their name and member ID in area 801, answer questions identifying the patent in area 802, represent they are the OPO in area 802, and list all current and prior licenses in area 803. OPOs state the number of POPs and PUCs they wish issued, the transaction period, and how they wish to handle maintenance fees in area 805. Definitions of abbreviations and terms used on this page appear in area 806. Area 804 affords OPOs the opportunity to tune various conditions associated with the conditional assignment, such as 1) whether the number of fractions owned by the OPO should be published; 2) the value of the percentage of fractions needed by a PNPO to acquire ownership interest in the patent; 3) how to split or reverse split fractions; and 4) parameters associated with the rules of acquisition.

If a member enters his member name and password in area 305 of FIG. 3, his name is checked in ePatentTrade's database. If it is present, and his entered password matches the password in the database, he is directed via scrolling region 503 to information presented in FIG. 9. Screen area 901 displays fields 902 from the member's ePatentTrade account. Every member has a bank account outside of ePatentTrade where money is exchanged from his internal ePatentTrade account. The name of the external bank is listed in section 902 along with balances and other pertinent account information relating to his internal ePatentTrade account. Screen area 903 shows what fractions the member currently owns. Section 904 displays the patent number, whether the fraction is a POP or PUC, and the volume owned. Screen area 905 displays the patent fractions available for trading. Section 906 lists fields from the ePatentTrade database most pertinent to this member. Since different members may wish to emphasize different fields in the database, this view is customizable via a preferences dialog box available as a pull down item from the application's top menu bar. One of the most important fields in section 906 is the labeled “Total Issued”, i.e., the total number of fractions (POP or PUC) for the patent identified by columns 2 and 3. If the transaction period is several years away, expected patent revenues divided by the total number of fractions equals the anticipated fraction price.

Section 906 can grow extremely large if all patents traded within ePatentTrade are listed. Members may select which patents are displayed by using a different screen. After a member selects which patent and fraction type he wishes to trade by clicking one of the buttons in the column labeled “Select”, he may proceed by clicking “New Transaction” button 907, or by canceling his input by clicking “Exit” button 908.

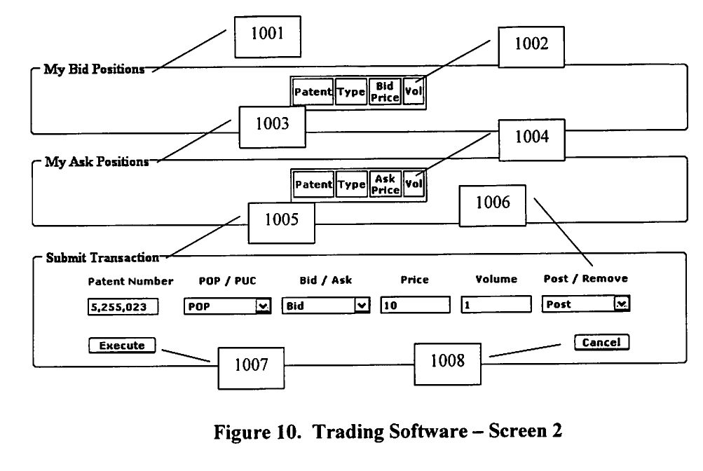

If the member clicks “New Transaction” button 907 scrolling region 503 displays information shown in FIG. 10. Screen area 1001 displays bids previously posted by the member. Information section 1002 lists the patent number, type (POP or PUC), bid price and volume. Screen area 1003 displays asks previously posted by the member. Information section 1004 lists the patent number, type (POP or PUC), ask price and volume. Screen area 1005 displays the patent number and fraction Type (POP or PUC) selected in the previous screen (FIG. 9). Selection boxes 1006 allow selection of specific parameters that control how the trade will progress. If members wish to post a bid or an ask they must specify the price and number of fractions they wish to trade. They may also delete a bid or ask they previously posted. To uniquely identify such a post, they must enter the price previously entered, along with how many posted fractions they would like to remove. If they wish to cancel their selections they may click “Cancel” button 1008. If they wish to execute their selections they will click “Execute” button 1007.

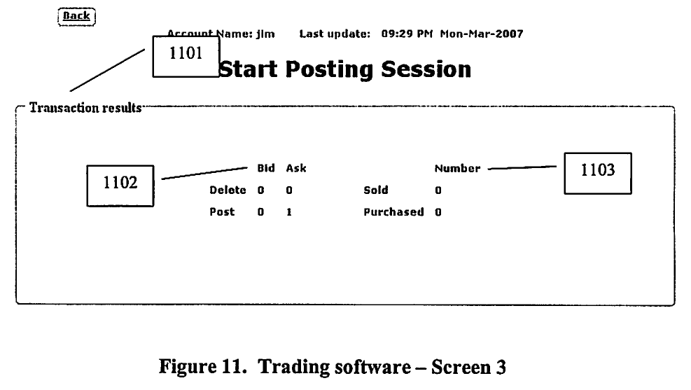

If the member clicks “Execute” button 1007 scrolling region 503 displays information shown in FIG. 11. Screen area 1101 shows the result of the transaction requested by the member via FIG. 10. The multiple combinations of transactions are summarized in tables 1102 and 1103. Table 1102 shows how many fractions were either posted or deleted. The posted transactions could be either bids or asks. In the event that a bid price was more or equal to an ask price, the number of fractions sold or purchased are listed in table 1103.

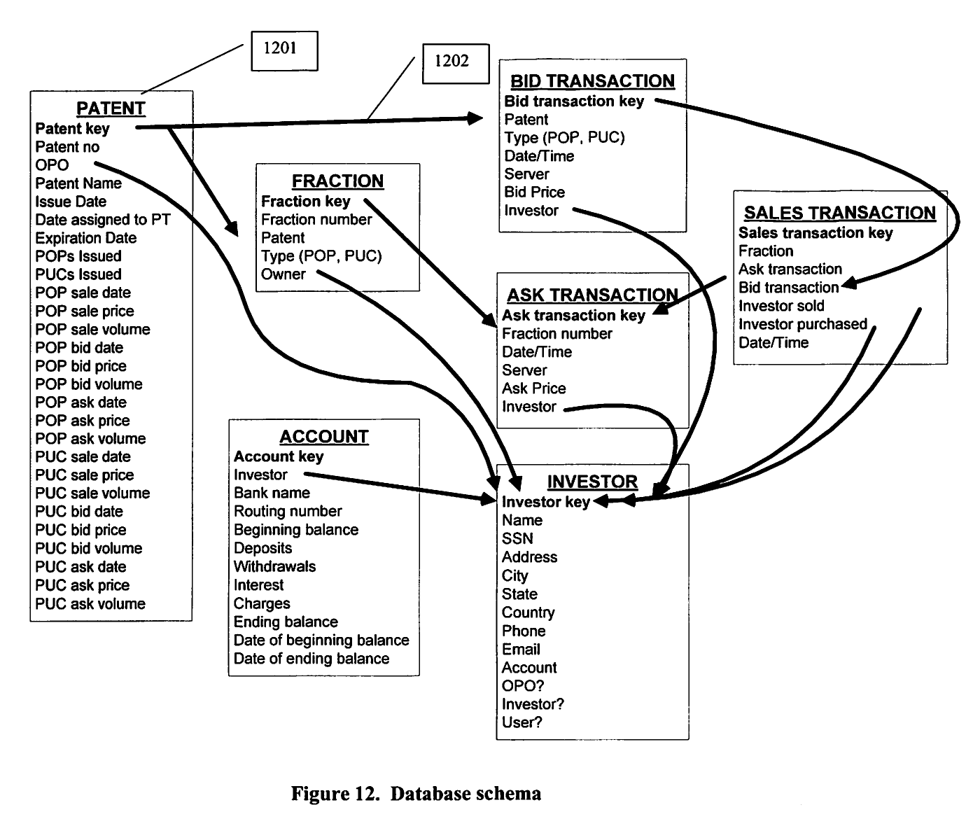

The database schema is shown in FIG. 12. The database is a collection of tables, such as table 1201, consisting of multiple records with multiple fields in each. Tables have associations with other tables, as shown by reference 1202.

The ePatentTrade database is divided into 7 tables:

### 1) The account table stores information about a member's internal account and his external bank account;

### 2) The fraction table records a unique serial number for a particular fraction, POP or PUC, and identifies the patent it is a fraction of, and the current owner.

### 3) The investor table contains contact and identification information as well as the investor's login name and password;

### 4) The patent table stores the latest bid, ask, and sale prices and volumes as well as patent identification information;

### 5) The ask table records information to completely describe an ask post;

### 6) The bid table records information to completely describe a bid post; and

### 7) The sale table records all information related to the transfer of a fraction when a posted bid price was greater or equal to a posted ask price.

Details describing the fields in each record are listed in Table 1.

TABLE 1
Description of table fields in ePatentTrade database.

| Table | Field | Type | Example | Description |
|---|---|---|---|---|
| Account | account_key | int(10) unsigned | 1 | Unique key for every |
| | | | | account |
| | investor | int(10) unsigned | 1 | Points to unique investor |
| | | | | record |
| | bank_name | char(40) | Citibank | |
| | routing_number | char(40) | 234000235 | |
| | beginning_balance | int(11) | 1000 | |
| | deposits | int(11) | 34 | |
| | withdrawals | int(11) | 15 | |
| | interest | int(11) | 0 | |
| | charges | int(11) | 0 | |
| | ending_balance | int(11) | 1019 | |
| | date_of_beginning_bal. | date | 2006-09-15 | |
| | date_of_ending_balance | date | 2006-10-15 | |
| Fractions | fraction_key | int(10) unsigned | 2 | Unique key for every POP |
| | | | | or PUC |
| | fraction_number | char(20) | 5255023000002 | Unique string for each POP |
| | | | | or PUC |
| | patent | int(10) unsigned | 1 | Patent key |
| | type | enum(‘POP’, PUC’) | POP | |
| | owner | int(11) | 1 | Owner key |
| Investor | investor_key | int(10) unsigned | 1 | Unique key for every |
| | | | | investor |
| | name | char(40) | Jim Bowl by | |
| | ssn | char(20) | 123-45-6789 | |
| | address | char(40) | 123 Harvest Lane | |
| | city | char(40) | Denver | |
| | state | char(5) | CO | |
| | country | char(20) | USA | |
| | phone | char(20) | 408-444-9898 | |
| | email | char(40) | jimy@epatenttrade.com | |
| | login_name | char(40) | jim | |
| | login_password | char(40) | jb | |
| | account | int(11) | 1 | Pointer to account record |
| | opo_q | enum(‘True’, ‘False’) | True | |
| | investor_q | enum(‘True’, ‘False’) | True | |
| | user_q | enum(‘True’, ‘False’) | False | |
| Patent | patent_key | int(10) unsigned | 1 | Unique key for every patent |
| | patent_number | char(20) | 5255023 | Patent number from |
| | | | | USPTO |
| | opo | int(10) unsigned | 1 | Pointer to owner |
| | patent_name | char(100) | Improved paper | |
| | | | marking | |
| | issue_date | date | 1993-10-19 | |
| | date_assigned_to_ePT | date | 2006-10-10 | |
| | expiration_date | date | 2011-10-09 | |
| | POPs_issued | int(11) | 4 | |
| | PUCs_issued | int(11) | 2 | |
| | POP_sale_date | date | 2006-12-03 | |
| | POP_sale_price | int(11) | 15 | |
| | POP_sale_volume | int(11) | 1 | |
| | POP_bid_date | date | 2006-12-03 | |
| | POP_bid_price | int(11) | NULL | |
| | POP_bid_volume | int(11) | NULL | |
| | POP_ask_date | date | 2006-12-03 | |
| | POP_ask_price | int(11) | NULL | |
| | POP_ask_volume | int(11) | NULL | |
| | PUC_sale_date | date | 2006-12-03 | |
| | PUC_sale_price | int(11) | 11 | |
| | PUC_sale_volume | int(11) | 1 | |
| | PUC_bid_date | date | 2006-12-03 | |
| | PUC_bid_price | int(11) | 10 | |
| | PUC_bid_volume | int(11) | 1 | |
| | PUC_ask_date | date | NULL | |
| | PUC_ask_price | int(11) | NULL | |
| | PUC_ask_volume | int(11) | NULL | |
| Ask | ask_key | int(10) unsigned | 4 | Unique key for active |
| | | | | posted asks |
| | fractions | int(10) unsigned | 14 | Pointer to POP or PUC |
| | date | timestamp | 2007-02-08 00:08:55 | |
| | server | char(20) | 1 | |
| | ask_Price | int(10) unsigned | 25 | |
| | investor | int(10) unsigned | 1 | Pointer to posting investor |
| Bid | bid_key | int(10) unsigned | 1 | Unique key for active |
| | | | | posted bids |
| | patent | int(10) unsigned | 2 | Pointer to patent |
| | type | enum(‘POP’, ‘PUC’) | POP | |
| | date | timestamp | 2006-11-04 14:32:25 | |
| | server | char(20) | 1 | |
| | bid_Price | int(10) unsigned | 10 | |
| | investor | int(10) unsigned | 1 | Pointer to posting investor |
| Sale | sales_key | int(10) unsigned | 1 | Unique key for sale |
| | | | | transactions |
| | fractions | int(10) unsigned | 1 | Pointer to POP or PUC sold |
| | ask | int(10) unsigned | 2 | Pointer to posted Ask |
| | bid | int(10) unsigned | 105 | Pointer to posted Bid |
| | investor_sold | int(10) unsigned | 1 | Pointer to selling investor |
| | investor_purchased | int(10) unsigned | 4 | Pointer to buying investor |
| | date | timestamp | 2006-12-02 23:58:51 | |
| | price | int(10) unsigned | 11 | |

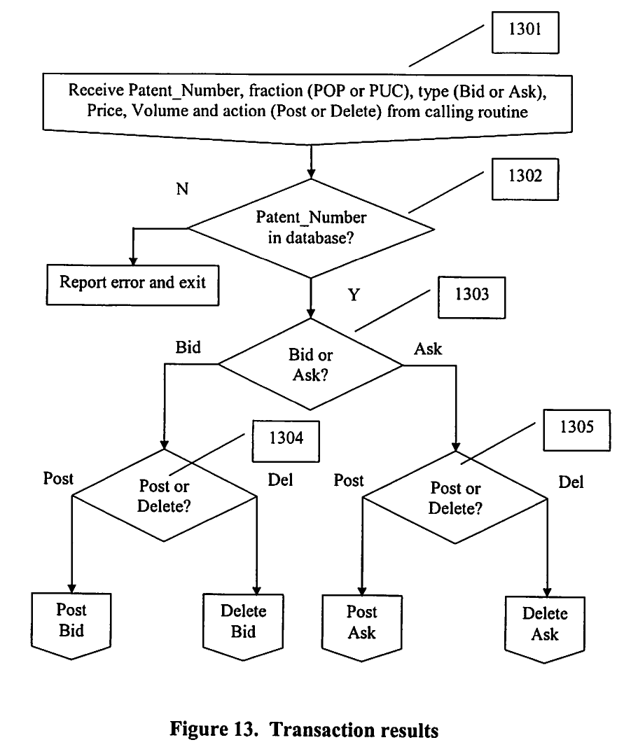

Controller processes are implemented as PHP server side scripts, and are either simple procedures or complicated functions. The simple procedures are embedded within their respective web pages. Complicated functions, diagrammed in FIGS. 13-16 and described more fully below, are stored as PHP functions and included as a header in every web page. In the following descriptions, algorithm variables are displayed in italics.

The simple procedures are:
1) Login from user interface screen 1.
   a) Member enters Member_Name and Member_Password.
   b) Retrieve the investor record from the ePatentTrade database with Investor_name=Member_Name.
   c) If Member_Name is not in the ePatentTradedatabase, issue an error message titled “Invalid Member Name”.
   d) If Member_Password does not equal login_password stored in the investor record, issue an error message titled “Invalid Password”.
   e) If Member_Password equals login_password stored in the investor record, invoke trading software screen 1.
2) Trading software screen 1.
   a) Display Member_Name, Date and Time of last update.
   b) “Refresh” button updates information on this page.
   c) Display member's internal account information.
   d) Display the fractions and types (POP, PUC) owned by the member.
   e) List patents to trade, a list previously selected by the member.
   g) Member selects patent and type (POP, PUC) to trade.
   h) “Exit” returns to user interface screen 1.
   i) “New Transaction” button invokes trading software screen 2.
3) Trading software screen 2.
   a) Display Member_Name, Date and Time of last update.
   b) Enter “Back” to display trading software screen 1.
   c) Display member's bid posts.
   d) Display member's ask posts.
   e) Select the specifics of this trade:
      Check which Patent_Number to trade.
      Select POP or PUC.
      Select bid or ask.
      Enter price.
      Enter volume.
      Select “Post” to post a bid or ask, or “Delete” to remove a previously posted bid or ask.
   f) Enter the “Cancel” button to return to trading software screen 1.
   g) Enter the “Execute” button to invoke trading software screen 3.

The results of posting or trading are shown in trading software screen 3. Between trading software screen 2 and trading software screen 3, complicated functions are executed to determine which, if any, database records need to be changed. The first complicated function is shown in FIG. 13 and is called “Transaction results”. It starts at step 1301 by receiving transaction specific variables from trading software screen 2, namely: Patent_Number, POP or PUC, Bid or Ask, Price, Volume, and action (Post or Delete). Step 1302 attempts to locate the patent record in the ePatentTrade database. If it cannot be found an error is displayed and the routine stops. Steps 1303, 1304 and 1305 select which subsequent function should be called, depending on the values of Bid or Ask, and action. The result of these decisions is to call “Post Bid”, “Delete Bid”, “Post Ask” or “Delete Ask”.

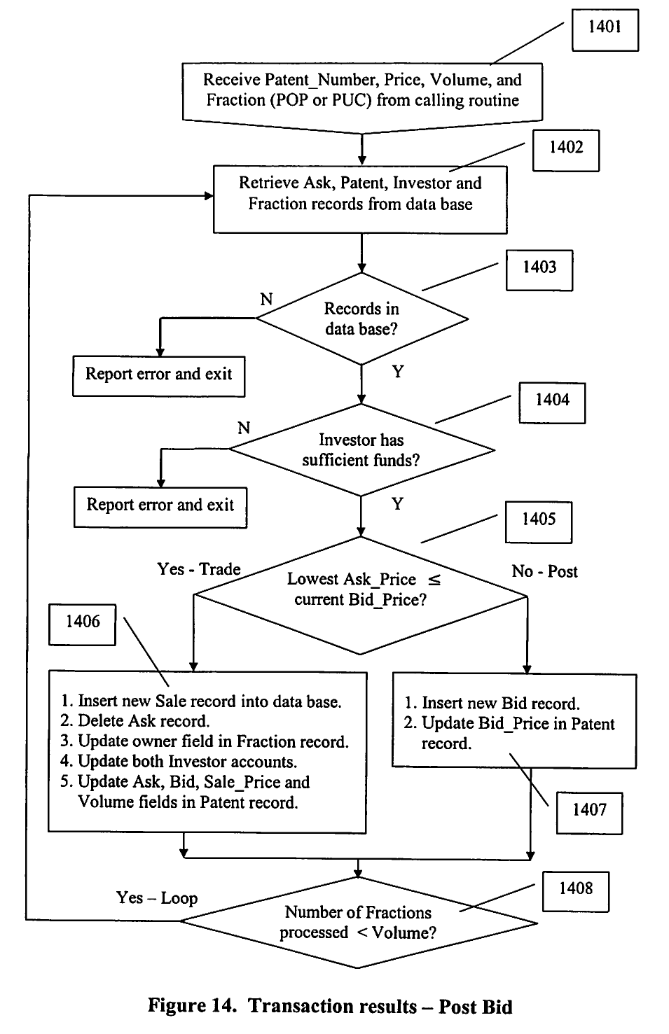

FIG. 14 diagrams the steps for posting a bid. Step 1401 retrieves specific variables from “Transaction results”, namely: Patent_Number, Price, Volume, and whether the fraction is a POP or PUC. A new bid record will be posted for each requested bid. For example, if the Volume is 4, then 4 bid records will be inserted into the ePatentTrade database. Steps 1402 through 1408 constitute a loop that iterates for each requested bid. The loop stops at step 1408 when it has executed Volume number of times. Step 1402 retrieves information from the database pertinent to this transaction. Step 1403 checks to see if the Patent_Number is in the database. If not, an error is displayed and the routine stops. The rules of ePatentTrade require a member to have sufficient funds in his account before he can initiate a trade. Therefore, step 1404 sees if the member has funds equal to the Bid_Price times the Volume. If the member does not have sufficient funds an error is reported and all further processing stops. The lowest Ask_Price is determined from the patent record (either POP_ask_price or PUC_ask_price depending on whether POPs or PUCs are traded in this transaction). In step 1405 if the lowest Ask_Price is less than or equal to the current Bid_Price a trade is initiated. Otherwise, step 1407 inserts a new bid record into the database and, if the current Bid_Price is greater than all other bid prices for this patent fraction, updates the bid price in the patent record (either POP_ask_price or PUC_ask_price depending on whether POPs or PUCs are traded in this transaction).

Step 1406 is executed if a trade is initiated. A new sale record is inserted into the database recording what fraction traded at what price, which bid and ask records initiated the trade, who the seller and buyer was, and when the sale occurred. A bid record is momentarily constructed and then immediately deleted, as is the previous ask record. The owner field in the fraction record is updated, and the bid, ask and sale fields in the patent record are updated. Step 1408 starts again at step 1402 Volume number of times.

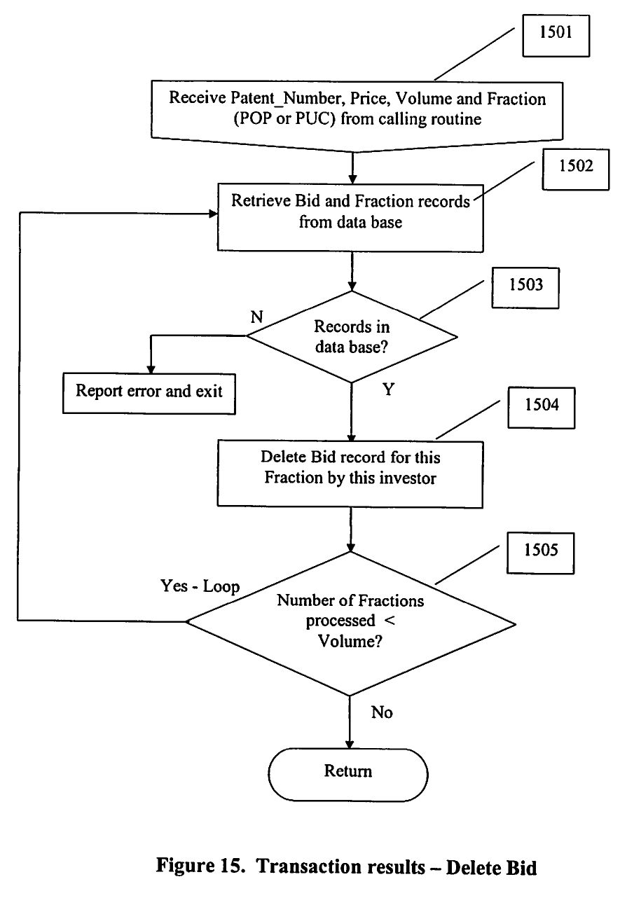

FIG. 15 diagrams the steps for deleting a previously posted bid. Step 1501 retrieves specific variables from “Transaction results”, namely: Patent_Number, Price, Volume, and whether the fraction is a POP or PUC. Step 1502 searches the database for this bid posting. If no such posting is found (step 1503) then an error is reported and execution stops. Otherwise, the bid record is deleted in step 1504. Step 1505 repeats this process from step 1502 until Volume number of bids are deleted.

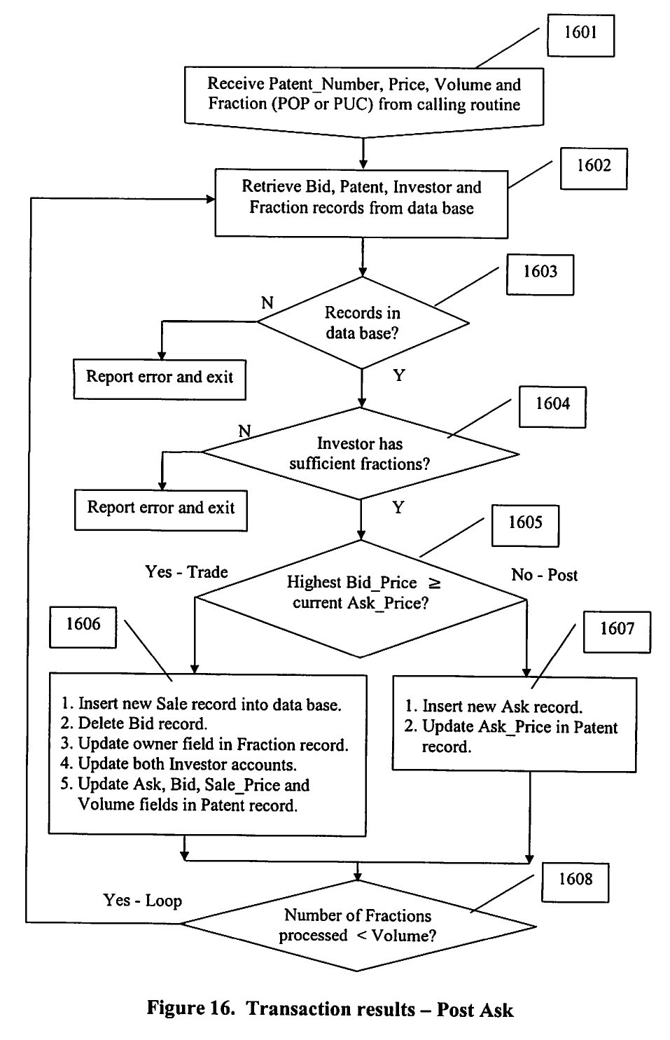

FIG. 16 diagrams the steps for posting an ask. Step 1601 retrieves specific variables from “Transaction results”, namely: Patent_Number, Price, Volume, and whether the fraction is a POP or PUC. A new ask record will be posted for each requested ask. For example, if the Volume is 4, then 4 ask records will be inserted into the ePatentTrade database. Steps 1602 through 1608 constitute a loop that iterates for each requested ask. The loop stops at step 1608 when it has executed Volume number of times. Step 1602 retrieves information from the database pertinent to this transaction. Step 1602 checks to see if the Patent_Number is in the database. If not, an error is displayed and the routine stops. The rules of ePatentTrade require a member to own the fractions he wishes to sell. Therefore, step 1604 sees if the member has enough fractions in his account to cover the ask volume. If the member does not have enough fractions an error is reported and all further processing stops. The highest Bid_Price is determined from the patent record (either POP_bid_price or PUC_bid_price depending on whether POPs or PUCs are traded in this transaction). In step 1605 if the highest Bid_Price is greater than or equal to the current Ask_Price a trade is initiated. Otherwise, step 1607 inserts a new ask record into the database and, if the current Ask_Price is less than all other ask prices for this patent fraction, updates the ask price in the patent record (either POP_ask_price or PUC_ask_price depending on whether POPs or PUCs are traded in this transaction).

Step 1606 is executed if a trade is initiated. A new sale record is inserted into the database recording what fraction traded at what price, which bid and ask records initiated the trade, who the seller and buyer was, and when the sale occurred. An ask record is momentarily constructed and then immediately deleted, as is the previous bid record. The owner field in the fraction record is updated, and the bid, ask and sale fields in the patent record are updated. Step 1608 starts again at step 1602 Volume number of times.

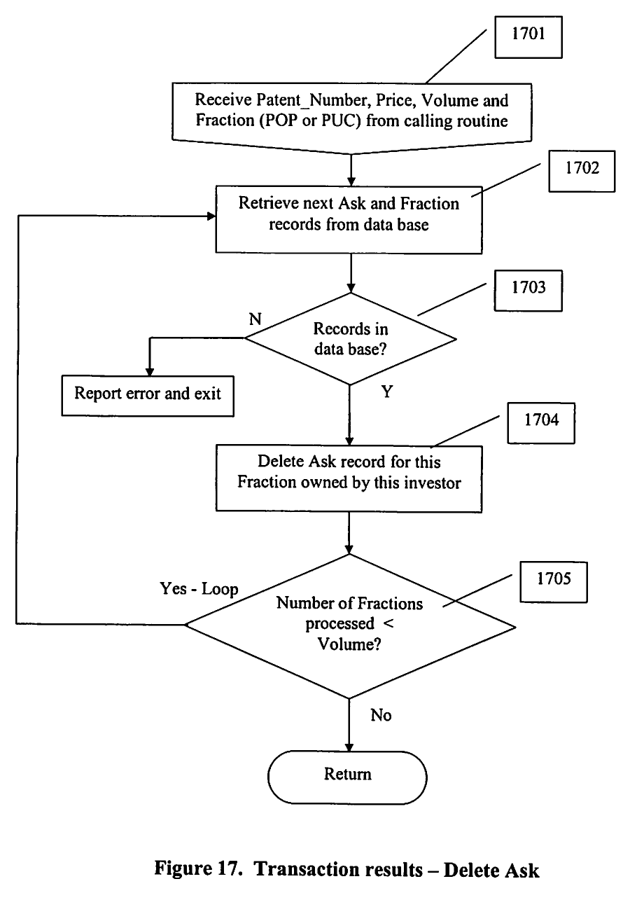

FIG. 17 diagrams the steps for deleting an ask. Step 1701 retrieves specific variables from “Transaction results”, namely: Patent_Number, Price, Volume, and whether the fraction is a POP or PUC. Step 1702 searches the database for this ask posting. If no such posting is found (step 1703) then an error is reported and execution stops. Otherwise, the ask record is deleted in step 1704. Step 1705 repeats this process from step 1702 until Volume number of asks are deleted.

FIG. 18 shows the interaction between the major external actors and the exchange. The exchange in this figure is called “ePatentTrade”. Actors are people or entities that both have a vested interest in the behavior of the exchange and can initiate behavior.

Actors operate under five different levels of security: local actors 1.1 through 1.4 in physical proximity of the servers 2.1 through 2.5 are considered the most secure. Customer Support 6.1 and 6.2, and the Compliance Officer 7.1 directly access the database 2.1 and are considered highly secure; if they connect remotely they must establish a very secure point-to-point connection. Other actors are interfaced to the system via a firewall. Random viewers 3.1, 3.3 and 3.4 of the exchange's website are considered not secure, member transactions 4.1 through 4.6 must be secure, and electronic funds transfer 5.1, oversight services 5.2, 5.3 and 5.5, and electronic trading 5.4 need to be very secure.

Table 2 is a spread sheet summarizing the use case goals of the actors shown in FIG. 18. Numbers and names are defined in FIG. 18. Goals are the primary desired action. Since these are the primary goals, they are preconditioned on two very strong assumptions: the actor is who we think he is, and that the statements made by the actor (on web pages or in notarized documents delivered to the exchange) are indeed correct.

TABLE 2
Description of exchange actors and use goals.

| Name | Summary | Use Goals |
|---|---|---|
| 1.1 Computer Maintenance | Insure H/W and S/W working properly. | Run H/W diagnostics |
| | | Fix/replace faulty H/W |
| | | Run S/W diagnostics |
| | | Install Operating system releases |
| | | Insure security/block, remove viruses |
| | | Recover from crash/power fail |
| | | Backup server and store offsite |
| 1.2 Release Engineer | Apply new S/W releases to production servers | Receive new software from Engineering |
| | | Test new software |
| | | Design incremental releases |
| | | Insure seamless performance for inc. rel. |
| | | Insure servers are S/W bug free |
| 1.3 Data Base Administrator | Responsible for accuracy, integrity of data base | Install new data base S/W releases |
| | | Backup database and store offsite |
| | | Recover data base from crash/power fail |
| | | Insure data base security |
| | | Support regulatory or oversight audit |
| 1.4 Auditor | On site audit of trade activity, trade histories | Access ePT data base |
| | | Produce reports |
| 2.1 Data Base | Exchange's persistent storage | Store New-Member information account |
| | | Store Member trading account |
| | | Save new patent abstracts |
| | | Store Tool algorithms |
| | | Store Trade algorithms |
| 2.2 Accounting | Member's internal ePT account | Save external bank account info |
| | | Transfer money between external bank account |
| | | Deposit interest on cash deposits |
| | | Deduct ePT commissions from trades |
| 2.3 Statistics | Summary statistics | Save historical prices of all patent fractions |
| | | Compute fraction trends |
| | | Access tool algorithms to estimate patent valuation |
| | | Access tool algorithms to estimate fraction prices |
| 2.4 Auditor Data Base | Items auditors would like recorded | Produce ongoing audit reports |
| 3.1 Non-Member | General information to web viewers | Display home page |
| | | Show information about trading fractions |
| | | Run simulation |
| | | Display tools: pricing patents & fractions |
| | | Display fraction summary statistics |
| | | Display tutorial for choosing patents of interest |
| | | Display tutorial for posting bids and asks |
| 3.2 USPTO | Specific information about patents | Request patent, PAIR records from www.USPTO.gov |
| 3.3 Web crawler | External programs seek to classify ePT content | Provide terms and metaterms describing ePT |
| | | Select descriptive terms that insure wide exposure |
| | | Purchase descriptive terms on search engines |
| 3.4 Hacker | Deny access | Detect malicious web requests |
| | | Identify origin and deny service |
| | | Repair any damage and recover true data |
| | | Report activity to other agencies |
| 3.5 Tool Algorithms | Public domain price estimators | Identify fractions of patents in similar classifications |
| | | Compute price of similar patents |
| | | Compute price of fractions nearing end of auction period |
| 4.1 Member Wanabe | A non-member applies for membership | Request personal identification information |
| | | Open an information account |
| | | Assign new password and password hint |
| | | Display forms to apply for exchange membership |
| | | Receive and process membership application form |
| 4.2 Members | A member opens a trading account | Approve membership application |
| | | Open a trading account |
| | | Request initial transfer of funds from Member's bank |
| | | Initiate funds transfer |
| | | Complete funds transfer |
| 4.2.1 New Member | Prepare for trading | Select patents of interest to track and display |
| | | Post first bid, either POP or PUC |
| 4.2.2 OPO | Offer new patent to ePT | Review background information on offering patents to |
| | | ePT |
| | | Obtain forms for assignment to OPO |
| | | Submit notarized documents to ePT |
| | | Complete web forms regarding OPO's ownership |
| | | Complete web forms regarding patent encumbrances |
| | | Specify number of fractions, auction period, maint. Fees |
| | | Configure conditions of assignment to ePT |
| 4.2.3 Investor | Buy and sell patent fractions | Log into Member account |
| | | Review trading account information |
| | | Review/modify patents of interest |
| | | Post a bid to buy a fraction |
| | | Post an ask to sell a fraction |
| | | Remove a previously posted and still active post |
| | | Receive notification of trade (posted bid and ask cross) |
| 4.2.4 Patent User | Obtain a 1 year license | Purchase PUC (see 4.2.3) |
| | | Notify ePT (web page) that user wishes to exercise PUC |
| | | Identify user, specify exercise dates |
| | | Receive from ePT 1 year license certificate |
| | | ePT removes PUC from active trading |
| 4.2.5 PNPO | Attempt to acquire all outstanding patent rights | Purchase 5%-10% of POPs (see 4.2.3) |
| | | Notify ePT (web page) that Member is a PNPO |
| | | Follow ePT Rules of Acquisition |
| 4.2.6 NPO | New Patent Owner | Purchase all outstanding POPs and PUCs |
| | | Notify ePT (web page) of successful acquisition |
| | | ePt assigns patent to NPO |
| 4.3 USPTO | Timely communication with USPTO | Pay maintenance fees if due during auction period |
| | | Record conditional assignment to ePT |
| | | If patent purchased, record assignment to NPO |
| | | If auction period expired, record assignment to OPO |
| | | Obtain patent expiration date |
| | | Track patent maintenance fee due dates |
| | | Track grace period (payment with surcharge) |
| 4.4 POP | Patent fraction: piece of the patent | ePT creates POPs with specific serial numbers (see |
| | | 4.2.2) |
| | | If auction period expires, deactivate trading of POPs |
| | | If NPO purchases all POPs, deactivate trading of POPs |
| | | Issue new POPs to investors if expired patent is relisted |
| | | Split POPs, or reverse split, depending on OPO pref. |
| 4.5 PUC | Patent fraction: patent use contract | ePT creates PUCs with specific serial numbers (see |
| | | 4.2.2) |
| | | If auction period expires, deactivate trading of PUCs |
| | | If PUC is exercised, deactivate trading of PUC |
| | | If NPO purchases all PUCs, deactivate trading of PUCs |
| | | During acquisition moratorium, deactivate trading of PUCs |
| | | Issue new PUCs to investors if expired patent is relisted |
| 4.6 Trade Algorithms | Generate trades from bid/ask posts | Examine posted bids and posted asks |
| | | When a new bid is >= ask, generate a trade |
| | | When a new ask is <= bid, generate a trade |
| | | Remove participating bid and ask. |
| 5.1 Banks | Exchange money with Member's bank | Deposit funds from bank into Member's trading account |
| | | Deposit funds from Member's trading account into bank |
| | | Request historical transaction information |
| | | Notify ePT of change of account status |
| 5.2 Government regulators | Provide visibility to government regulators | Request information on specific trades |
| | | Request summary information |
| | | Deliver ongoing reports |
| 5.3 Oversight organization | Provide visibility to oversight organizations | Request information on specific trades |
| | | Request summary information |
| | | Deliver ongoing reports |
| | | Resolve Member disputes |
| 5.4 Electronic trading | Support programmed trading | Request information via FIX (Financial information |
| | | exchange) |
| | | Post bids/ask via FIX |
| | | Exchange financial transfers via FIX |
| 5.5 Remote Maintenance | Insure H/W and S/W working properly. | Run H/W diagnostics |
| | | Run S/W diagnostics |
| | | Install Operating system releases |
| | | Insure security/block, remove viruses |
| | | Recover from crash/power fail |
| | | Backup server and store offsite |
| 6.1 Non-Member wanting help | General web based inquiries | Request company/investor information |
| | | Find out how to become a member |
| | | Questions regarding web access |
| 6.2 Member wanting help | Specific trading and member support inquiries | How to complete online forms |
| | | Technical (H/W, S/W) support |
| | | How to use ePT software and trading system |
| | | Where to get information (FAQs) |
| | | Respond to accounting inquiries |
| | | Online support groups |
| | | How to trade without a computer |
| 7.1 Compliance Officer | Internal oversight of all postings and transactions | Authenticate statements made by members and non- |
| | | members |
| | | Act on false statements |

While the invention has been described with respect to certain embodiments and applications, it will be appreciated that various changes and modification may be made without departing from the spirit o the invention, as embodied in the following claims.

What is claimed is:

1. A method for buying and selling, through an on-line exchange, ownership, license or conditional rights in a legal contract, patent, trademark, or copyright, said method comprising,
(a) obtaining a conditional transfer of said rights subject to certain conditions being met, and setting a transaction period during which the transferred rights may be bought and sold on the exchange,
(b) dividing the transferred rights into fractions, each of which represents a defined fraction of the transferred rights;
c) allowing the individual fractions of transferred rights to be bought and sold by participants in the exchange, whereby buyer participants can purchase one or more of said fractions from seller participants at agreed upon prices during the transaction period, and
(d) continuing the buying and selling of fractions until the earlier of the following terminating events occurs:
(i) if the transferred right is an ownership right, one of the participants acquires an dominant ownership interest in the transferred rights by acquiring a specified percentage of fractions of the transferred rights, in which case that participant can become the owner of the transferred ownership rights by acquiring all other ownership fractions in the rights at a predetermined price; or
(ii) the specified transaction period expires.

2. The method of claim 1, wherein obtaining the conditional transfer of rights in step (a) includes obtaining a conditional assignment by the owner of the rights or obtaining a promise from the owner of the rights to transfer such rights upon certain conditions being met.

3. The method of claim 1, wherein the type and number of fractions of transferred rights in step (b), and the transaction period during which the transferred rights can be bought and sold, are set by the owner of the rights and revealed to all of the participants.

4. The method of claim 1, wherein step (d)(i) includes recording the intention of a buyer participant to acquire a full ownership interest in the transferred ownership rights, and allowing that participant a given period of time in which to acquire said specified number of ownership fractions.

5. The method of claim 4, wherein said buyer participant is the only purchaser allowed to purchase fractions for said given period of time.

6. The method of claim 4, wherein two or more buyer participants record their intention to acquire full ownership interest in the contract rights, further comprising conducting an auction in which the two or more interested buyers bid for the right to be the sole buyer participant.

7. The method of claim 1, wherein the transferred rights are license or conditional rights to use a patent for a specified period of time that is a percentage of the unexpired period of the patent.

8. The method of claim 7, wherein the fractions bought by a participant buyer may be sold to another participant buyer or bought by a participant buyer who has acquired a full ownership interest in the patent.

9. The method of claim 1, wherein the transferred right is a patent ownership right, and the percentage of fractions that triggers the end of the bidding and selling in step (d)(i) is between 50 and 80 percent of the fractions of the transferred ownership rights.

10. The method of claim 1, wherein the transferred right is a patent right, and the time period that triggers the end of the bidding in step specified (d)(i) is greater than 6 months and up to the expiry date of the patent. i

11. The method of claim 1, wherein the exchange is a continuous auction market comprising
(g) members who join the exchange by signing a contract in which they agree to abide by the rules of the exchange;
(h) an owner of rights who receives from the exchange fixed amounts of one or more types of fractions;
(i) a means by which members who own fractions can post asks to sell fractions, said ask offers remaining in effect for said transaction period, until the fractions are purchased, or until said member withdraws said post;
(j) a means by which members who wish to purchase fractions can post bids to buy fractions, said bid offers remaining in effect for said transaction period, until the fractions are purchased, or until said member withdraws said post;
(k) a means of displaying throughout the exchange the maximum bid and minimum ask for each type of fraction; and
(l) a mechanism for generating sales when the maximum bid price becomes greater than or equal to the minimum ask price.

12. The method of claim 1, wherein the owner of the rights can choose whether the number of fractions will remain fixed during said transaction period, or can be split if the price rises above a specified price limit, or reverse split if the price falls below a specified price limit.

13. The method of claim 1, wherein the owner of the rights can choose to publicly disclose throughout the exchange the number of fractions owned by that owner.

14. An on-line exchange for buying and selling ownership, license or conditional rights in a legal contract, patent, trademark or copyright, where such rights have been conditionally transferred to the exchange, said exchange comprising,
(1) a website server for communicating with participant computer terminals for exchanging information between participants, and
(2) a machine-readable storage medium operable on said server to carry out the operations of:
(a) storing bid and ask prices for fractions that each represent a defined percentage of the transferred ownership, license or conditional rights; as these prices change over time,
(b) determining when bid and ask prices intersect, and in response, transferring fractions from seller to buyer participants,
(c) determining that a termination event has occurred when (i) one of the participants acquires a dominant ownership interest by acquiring a specified number of fractions of transferred ownership rights, or (ii) a time period specified for the conditional transfer of rights expires, in which case all fractional ownership rights in said fractions are forfeited by non-owner participants has occurred,
(d) if the termination event is (ci), determining an ownership fraction price for all outstanding ownership fractions, and presenting this price to the participant who has acquired a dominant ownership interest by acquiring such specified number of ownership fractions, and
(e) if the termination event is (cii), closing all further bidding on and selling of fractions and informing all participants with ownership fractions that their fractions have expired.

15. The system of claim 14, wherein the exchange provides an escrow account into which an owner of the rights can conditionally transfer the rights for a specified period of time or until certain conditions precedent are met.

16. The exchange of claim 14, wherein step (2)(c)(i) includes recording the intention of a buyer participant to acquire a full ownership interest in the transferred rights, and determining a given time period in which that participant must acquire said specified number of ownership fractions.

17. The exchange of claim 14, wherein the contract owner chooses whether the number of fractions will remain fixed during said time period, or can be split if the price rises above a specified price limit, or reverse split if the price falls below a specified price limit.

18. The exchange of claim 14, wherein the contract owner chooses whether to publicly disclose throughout the exchange the number of fractions owned by the original contract owner.
